(19) United States
(12) Patent Application Publication
(10) Pub. No.: US 2024/0428373 A1
(43) Pub. Date: Dec. 26, 2024

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: MIZUKI MATSUBARA, Tokyo (JP)

(21) Appl. No.: 18/745,752

(22) Filed: Jun. 17, 2024

(30) Foreign Application Priority Data
Jun. 21, 2023 (JP) 2023-102040

(51) Int. Cl. G06T 3/40

(52) U.S. Cl. CPC G06T 3/40

(57) ABSTRACT

An image processing apparatus includes one or more processors and at least one memory, the at least one memory being coupled to the one or more processors and having stored thereon instructions executable by the one or more processors, wherein the execution of the instructions cause the image processing apparatus to function as an acquisition unit configured to acquire a first video, and a display control unit configured to control display so that a first display area where thumbnails of the first video are displayed is larger than a second display area where thumbnails of a second video are displayed in a case where an angle of view of the first video is larger than an angle of view of the second video.

### BACKGROUND OF THE DISCLOSURE

### Field of the Disclosure

The present disclosure relates to image processing for displaying a thumbnail image.

### Description of the Related Art

FIG. 1 illustrates an example of a display screen when video is reproduced by a video reproduction apparatus. In FIG. 1, a video display unit 1, a reproduction button 2, a seek bar, a mouse cursor 4, and thumbnail display area 5 are included. A position on the seek bar 3 is associated with a time of video. When the mouse cursor 4 is placed on the seek bar 3, a frame image for the video time associated with the position is displayed in the thumbnail display area 5 as a thumbnail. The thumbnail is used by a video viewer to understand temporal changes in a video during viewing, or the like.

A technique of generating a wide viewing angle video such as a panorama video or an entire-celestial-sphere video by combining videos captured through a lens with a wide angle of view, such as a fisheye lens, or a plurality of lenses has been achieved. As a method of generating the thumbnail for understanding a content of the wide viewing angle video, a method of cutting out a rectangle with a part of the angle of view in the video, generating the angle of view similar to a video with a normal angle of view, which is captured with a single standard lens, is known.

Meanwhile, only with such a partial angle of view, an area of a video that the viewer desires to check may not be visible in a thumbnail video. Accordingly, Japanese Patent No. 6337888 discusses that a panoramic view of a wide viewing angle video is generated as a thumbnail image by converting a resolution.

### SUMMARY OF THE DISCLOSURE

According to an aspect of the present disclosure, an image processing apparatus includes one or more processors and at least one memory, the at least one memory being coupled to the one or more processors and having stored thereon instructions executable by the one or more processors, wherein the execution of the instructions cause the image processing apparatus to function as an acquisition unit configured to acquire a first video, and a display control unit configured to control display so that a first display area where thumbnails of the first video are displayed is larger than a second display area where thumbnails of a second video are displayed in a case where an angle of view of the first video is larger than an angle of view of the second video.

Further features of the present disclosure will become apparent from the following description of exemplary embodiments with reference to the attached drawings.

### BRIEF DESCRIPTION OF THE DRAWINGS

FIG. 1 is a diagram illustrating an example of an image displayed by an image processing apparatus.

FIG. 2 is a diagram illustrating a hardware configuration of the image processing apparatus.

FIG. 3 is a diagram illustrating a functional configuration of an image processing apparatus according to a first exemplary embodiment.

FIG. 4 is a diagram illustrating a modification of the functional configuration of the image processing apparatus according to the first exemplary embodiment.

FIG. 5 is a flowchart illustrating processes of the image processing apparatus according to the first exemplary embodiment.

FIG. 6 is a diagram illustrating a functional configuration of an image processing apparatus according to a second exemplary embodiment.

FIG. 7 is a flowchart illustrating details of three-dimensional information acquisition processing of the image processing apparatus according to the second exemplary embodiment.

FIG. 8 illustrates an example of an attention area group storage table.

FIG. 9 is a flowchart illustrating an enlargement ratio calculation processing according to the second exemplary embodiment.

### DESCRIPTION OF THE EMBODIMENTS

Exemplary embodiments of the present disclosure will be described with reference to the drawings. The exemplary embodiments do not limit the present disclosure, but all combinations of features described in the present exemplary embodiment are not essential to the solution of the present disclosure. Identical components will be described with the same codes.

In the conventional technology, when a panoramic view is used as a thumbnail image, a visibility of the thumbnail image is reduced in a case where a display area for displaying the thumbnail image is not large enough.

A first exemplary embodiment discusses a method of calculating an enlargement ratio of a display area where a thumbnail image is displayed and enlarging a display area of the thumbnail image, based on viewing angle information or depth information. The thumbnail image is also referred to as thumbnail data.

### <Hardware Configuration of Image Processing Apparatus>

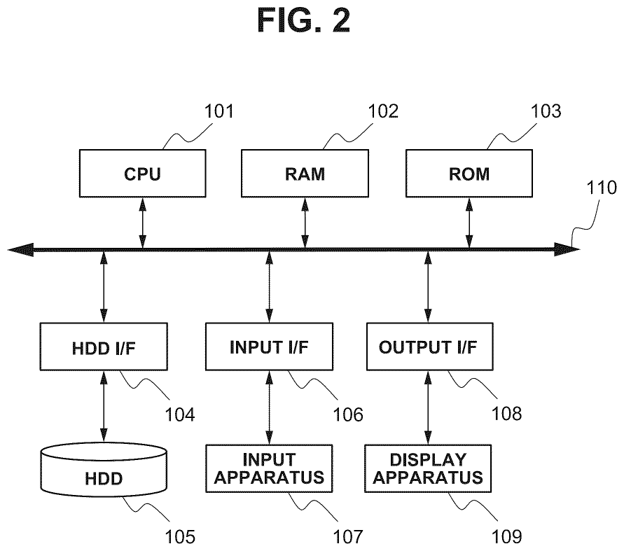

An example of a configuration of an image processing apparatus according to the present exemplary embodiment will be described with reference to FIG. 2. In FIG. 2, a central processing unit (CPU) 101 executes a program stored in a ROM 103 and a hard disk drive (HDD) 105 using a RAM 102 as a work memory, and controls an operation of each block, which will be described below, via a system bus 114. An HDD interface (interface is written as “I/F”) 104 connects a secondary storage device such as the HDD 105 or an optical disk drive. The HDD I/F 104 is, for example, an I/F, such as a serial ATA (SATA). The CPU 101 reads out data from the HDD 105 and writes data into the HDD 105, via the HDD I/F 104. Furthermore, the CPU 101 can develop data stored in the HDD 105 in the RAM 102, and the CPU 101 can also save the data developed in the RAM 102 in the HDD 105. The CPU 101 can execute the data developed in the RAM 102 as a program. An input I/F 106 connects an input apparatus 107 such as a keyboard, a mouse, a digital camera, scanner, or an acceleration sensor. The input I/F 106 is, for example, a serial bus I/F such as USB or IEEE1394. The CPU 101 can read data from the input apparatus 107 via the input I/F 106. An output I/F 108 connects an image processing apparatus 100 and a display apparatus 109. The output I/F 108 is, for example, a video output I/F such as DVI or HDMI (registered trademark). The CPU 101 can send data to the display apparatus 109 via the output I/F 108 and control the display apparatus 109 to display a predetermined video.

There are other components of the image processing apparatus 100 in addition to those mentioned above. For example, the input apparatus 107 and the display apparatus may not be included in the image processing apparatus 100. When the input apparatus 107 and the display apparatus 109 are not included, the CPU 101 controls an input from the input apparatus 107 as an input control unit, and controls a display on the display apparatus 109 as a display control unit.

### <Functional Configuration of Image Processing Apparatus>

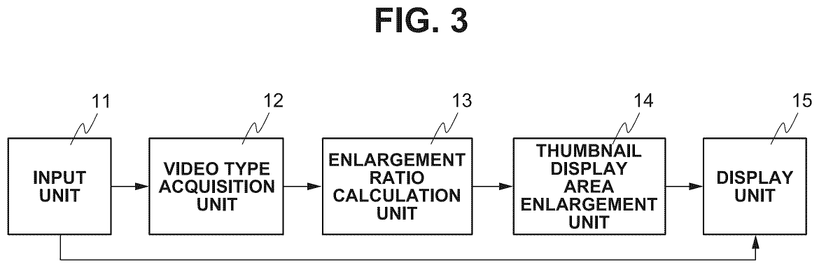

FIG. 3 is a block diagram illustrating a functional configuration of the image processing apparatus 100. In FIG. 3, the image processing apparatus 100 includes an input unit 11, a video type acquisition unit 12, an enlargement ratio calculation unit 13, a thumbnail display area enlargement unit 14, and a display unit 15.

The input unit 11 outputs a reproduction video and thumbnail data to the display unit 15. The input of an operation from a mouse, a keyboard, or the like is accepted and output to the display unit 15. Metadata of the reproduction video may be output to the video type acquisition unit 12.

The video type acquisition unit 12 acquires a video type. The video type is output to the enlargement ratio calculation unit 13.

The enlargement ratio calculation unit 13 calculates an enlargement ratio of a thumbnail data display area. The calculated enlargement ratio is output to the thumbnail display area enlargement unit 14.

The thumbnail display area enlargement unit 14 enlarges the thumbnail data display area. Thumbnail data display area information is output to the display unit 15.

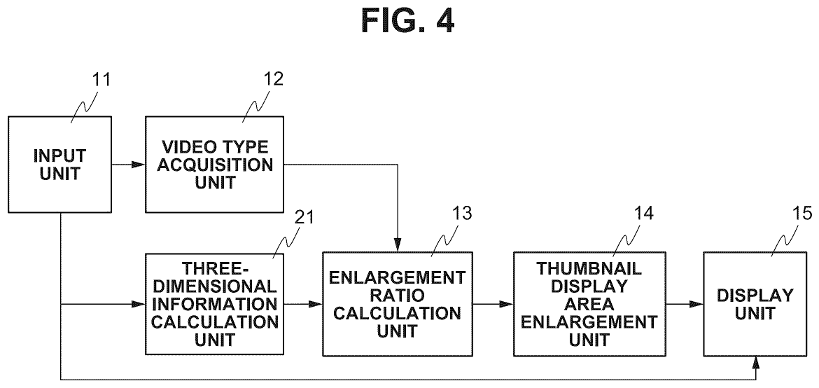

The image processing apparatus may further be equipped with a three-dimensional information calculation unit 21. FIG. 4 illustrates a block diagram illustrating a functional configuration in a case where the image processing apparatus is equipped with the three-dimensional information calculation unit 21. In FIG. 4, the image processing apparatus 100 includes an input unit 11, a video type acquisition unit 12, an enlargement ratio calculation unit 13, a thumbnail display area enlargement unit 14, a display unit 15, and the three-dimensional information calculation unit 21.

The input unit 11 may further acquire angle of view and depth video data of video images reflected in a wide viewing angle video and may output the data to the three-dimensional information calculation unit 21.

The three-dimensional information calculation unit 21 calculates three-dimensional information. The three-dimensional information is output to the enlargement ratio calculation unit 13.

### <Processing of Image Processing Apparatus>

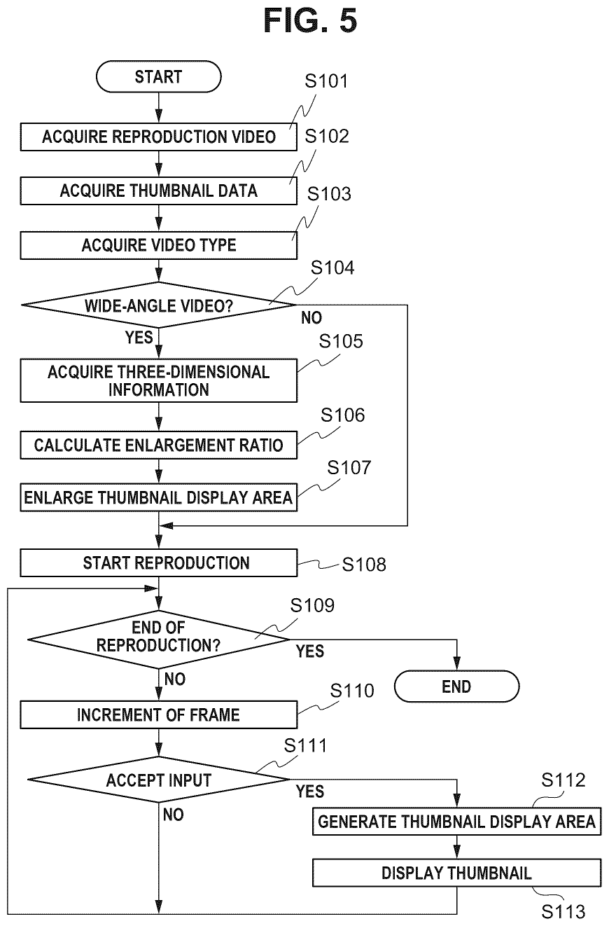

FIG. 5 is a flowchart illustrating processes to be executed by the image processing apparatus. Each step (process) is represented by adding S in front of each code.

In step S101, the input unit 11 acquires a reproduction video saved in the HDD 105 or the like.

In step S102, the input unit 11 acquires thumbnail data saved in the HDD 105 or the like.

In step S103, the video type acquisition unit 12 acquires a video type as video type information. The video type information is information indicating a type whether the reproduction video is a normal video or a wide viewing angle video. The wide viewing angle video is generated by combining video images captured by using a lens with a wide angle of view, such as a fisheye lens, or video images captured by using a plurality of lenses. The video type is acquired by reading metadata appended in advance by a photographer or the like. A method of acquiring a video type is not limited to the acquisition method of acquiring a video type from metadata. For example, an input from a video viewer is accepted from the input apparatus 107 or the like and then, a type designated by the input may be acquired. The wide viewing angle video is normally handled using a scheme called distance projection or equidistant cylindrical projection. The projection scheme may be acquired from metadata, and when the projection scheme used for a wide viewing angle video, such as distance projection or equidistant cylindrical projection, is used, it may be determined that the video type is a wide viewing angle video (first video). A video type that is not a wide viewing angle video is defined as a normal video (second video).

In step S104, when the video type is a wide viewing angle video, the processing proceeds to step S105. When the video type is a normal video, the processing proceeds to step S108.

In step S105, the three-dimensional information calculation unit 21 calculates three-dimensional information. An angle of view of a wide viewing angle video is acquired as the three-dimensional information. The angle of view is acquired from metadata of the video. (A horizontal angle of view and a vertical angle of view) of the wide viewing angle video are (FOV_H_TARGET, FOV_V_TARGET).

In step S106, the enlargement ratio calculation unit 13 calculates an enlargement ratio. As for the enlargement ratio, a reference angle of view of thumbnail data is defined in advance, for example, and the number of times the angle of view acquired in step S105 is in comparison with the reference angle of view is acquired. Assume that a reference angle of view in a horizontal direction and a reference angle of view in a vertical direction be (FOV_H_BASIC, FOV_V_BASIC). An enlargement ratio RATIO_X in a longitudinal direction of thumbnail data is calculated as in Formula (1), and an enlargement ratio RATIO_Y in a lateral direction is calculated as in Formula (2).

$$RATIO\_X = FOV\_H \_TARGET / FOV\_H \_BASIC \qquad ( 1 )$$

$$RATIO\_Y = FOV\_V \_TARGET / FOV\_V \_BASIC \qquad ( 2 )$$

In step S107, the thumbnail display area enlargement unit 14 enlarges a thumbnail data display area. A thumbnail display area of the normal video is set in advance and read from the HDD 105 or the like. A value acquired by multiplying a lateral width of the thumbnail display area in the normal video by RATIO_X is set as a lateral width of the thumbnail display area in a wide viewing angle video. Similarly, a longitudinal width of the thumbnail display area is set to be a longitudinal width acquired by multiplying a longitudinal width of the thumbnail display area in the normal video by RATIO_Y.

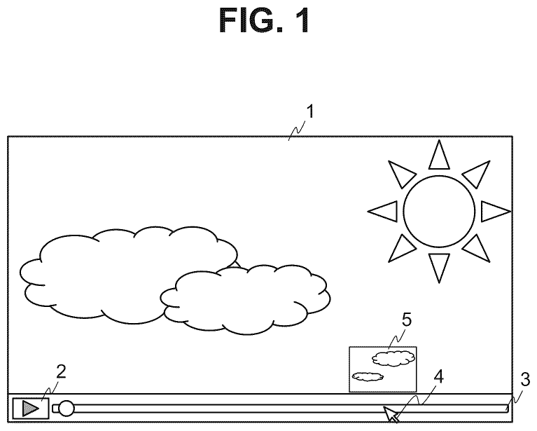

In step S108, the display unit 15 starts reproduction of a reproduction video. First, a display layer is configured in such a way as to have a display screen as in FIG. 1, for example, and displayed on the display apparatus 109. A zeroth frame image is displayed on a video display unit 1. Although FIG. 1 illustrates a thumbnail display area 5, no thumbnail display area is generated at the stage of step S108 in the present exemplary embodiment.

The display area is displayed when a mouse cursor is placed on a seek bar as described below. A layout and configuration of the display screen are not limited to the example. For example, the thumbnail display area 5 may be arranged in such a way as not to overlap the video display unit 1, and may be always displayed.

In step S109, the display unit 15 confirms whether a video being reproduced has ended. For example, it is assumed that when there is no next frame of the video being reproduced, the video has ended, and the image processing apparatus 100 ends the processing. When the video being reproduced has not ended, the processing proceeds to step S110.

In step S110, the display unit 15 increments the frame of the reproduction video according to a reproduction time, and reproduces the frame according to the reproduction time.

In step S111, the input unit 11 accepts an input from a viewer. For example, whether the mouse cursor is on the seek bar is acquired. When the cursor is on the seek bar, the processing proceeds to step S112. When no mouse cursor is on the seek bar, the processing proceeds to step S109. If the seek bar is clicked when the input is accepted, the processing may jump to a reproduction time indicated by the clicked seek bar.

In step S112, the display unit 15 generates a thumbnail display area. When the thumbnail display area has already been generated in step S108, it is not necessary to generate a thumbnail display area.

In step S113, the display unit 15 displays thumbnail data. When the thumbnail display area and thumbnail data are different in resolution, the thumbnail data are converted to match the resolution by being resized and then displayed. It is assumed that the thumbnail data includes the number of frames at a time corresponding to all frames of the reproduction video. Thumbnail data are generated by converting the resolution of each frame of the reproduction video. Among the frames, the frame at the time designated by the viewer using the seek bar is displayed on the thumbnail display area 5. Thumbnail data do not necessarily have to have the same number of frames as the reproduction video. By reducing the number of frames, it is possible to reduce a data amount of thumbnail data. When the number of frames is reduced, for example, the frame of thumbnail data at a time closest to the time designated using the seek bar is displayed.

In step S108, the image processing apparatus 100 does not necessarily have to end the processing, and may display thumbnail data of a video different from the video being reproduced, for example. By selecting thumbnail data, the viewer can start viewing the selected video. At this time, when the thumbnail data to be selected is a wide viewing angle video, the image processing apparatus 100 may calculate an enlargement ratio and enlarge the thumbnail data through the processing described in steps S105 and S106.

Although the entire angle of view of the thumbnail data is acquired in step S105, a partial angle of view may be acquired. For example, because an imaging apparatus is often installed in a horizontal direction to the ground, the sky and ground are often present at the top and bottom. An important subject is rarely present at an end in the vertical direction.

For this reason, an angle of view in the vertical direction may be narrowed as compared with the actual angle of view. At this time, the acquired thumbnail data are trimmed, thereby narrowing the angle of view of thumbnail data, and the narrowed angle of view is set to be (FOV_H_TARGET, FOV_V_TARGET). The thumbnail data may be spatially compressed using a known retargeting technique or the like, and the compressed angle of view may be used.

In step S101, the reproduction video is acquired, but the reproduction video may be reproduced on a streaming basis, which is acquired simultaneously with the reproduction. When streaming, the reproduction video is acquired from a distribution server that is connected via a communication interface, which is not illustrated.

When the thumbnail data themselves of a wide viewing angle video are enlarged to match the enlarged display area, the image quality may become low due to the enlargement processing. Usually, the resolution of thumbnail data is determined when a video producer uploads the video to a moving picture distribution service. An enlargement ratio may be calculated through the processing in steps S105 and S106, and the resolution of the thumbnail data to be uploaded may be enlarged according to the enlargement ratio. For example, thumbnail data are generated with a resolution acquired by multiplying the resolution of the thumbnail data of the moving picture distribution service to be uploaded by the calculated enlargement ratio. This makes it possible to reduce image quality deterioration due to enlargement processing.

In step S105, viewing angle information is used as the three-dimensional information, but depth information may also be used. A subject present at a location far from the imaging apparatus becomes smaller than the subject located close to the imaging apparatus. Accordingly, it may be desirable that a display area of thumbnail data of a reproduction video where many subjects are located far away from the imaging apparatus is made relatively larger than a display area of a reproduction video where many subjects are located close to the imaging apparatus. For example, when a wide viewing angle image is acquired using a plurality of lenses, a depth is acquired by using a known stereo matching technique. Measurement may be performed by using a distance measurement system such as Lidar, and the measurement results may be acquired. An average value of depth in the angle of view is acquired as depth information. The depth information is not limited to the average value of depth in the angle of view. For example, a depth of a detected person is acquired by using a known person detection technique. The depth of the person may be used as depth information. In this case, the enlargement ratio calculation unit 13 calculates an enlargement ratio, based on the depth information in step S106. For example, an enlargement ratio according to the depth is saved in the HDD 105 or the like in advance, and the enlargement ratio is calculated by reading the correspondence. For example, the correspondence between the depth and the enlargement ratio is acquired by actually conducting a preliminary investigation by manually enlarging and adjusting the thumbnail display area in such a way that a human-sized object can be visually recognized.

In step S106, the enlargement ratio is calculated by using three-dimensional information, but the enlargement ratio may be calculated without using the three-dimensional information. For example, if the video type acquired in step S103 is a wide viewing angle video, a predetermined enlargement ratio is acquired in such a way that the thumbnail display area is relatively larger than that of the normal video.

According to the present exemplary embodiment, thumbnail image with good visibility can be displayed even if the video type is a normal video or a wide viewing angle video.

In a second exemplary embodiment, a method of calculating an enlargement ratio will be described, based on a size of an attention area.

Visibility of important areas in thumbnail data is improved by enlarging a display area of the thumbnail data to a size at which the attention area can be visually recognized. A hardware configuration of an image processing apparatus in the present exemplary embodiment is the same as that in the first exemplary embodiment, and thus description of the hardware configuration will be omitted. Explanation will be mainly made on a different part between the present exemplary embodiment and the first exemplary embodiment. The identical components will be described by adding the same codes.

### <Functional Configuration of Image Processing Apparatus>

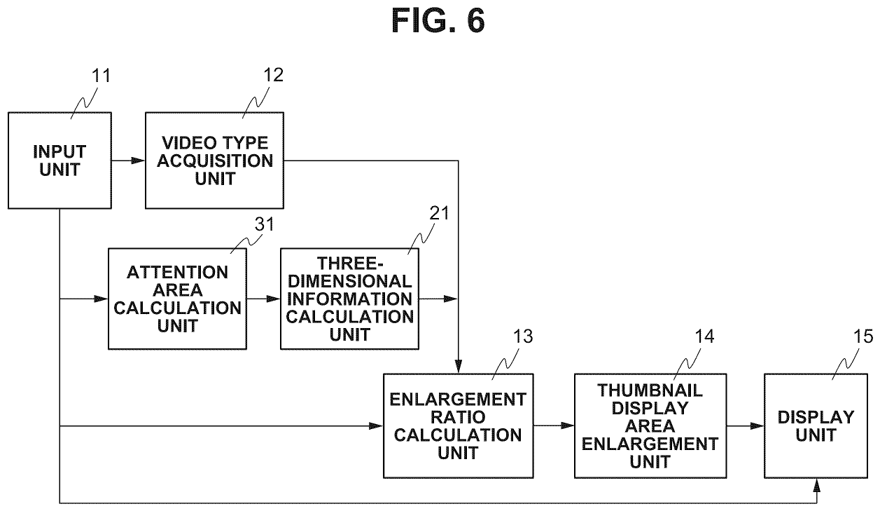

FIG. 6 is a block diagram illustrating a functional configuration of an image processing apparatus 100 according to the second exemplary embodiment. In FIG. 6, the image processing apparatus 100 includes an input unit 11, a video type acquisition unit 12, an enlargement ratio calculation unit 13, a thumbnail display area enlargement unit 14, a display unit 15, a three-dimensional information calculation unit 21, and an attention area calculation unit 31.

The input unit 11 may output viewpoint information, a reproduction video, and thumbnail data to the attention area calculation unit 31.

The attention area calculation unit 31 specifies an attention area. The specified attention area is output to the three-dimensional information calculation unit 21.

### <Processing of Image Processing Apparatus>

A flowchart to be executed by the image processing apparatus 100 is similar to that in the first exemplary embodiment. However, in step S105, a statistics amount of the size of the attention area is calculated as three-dimensional information, and in step S106, an enlargement ratio is calculated based on the statistics amount.

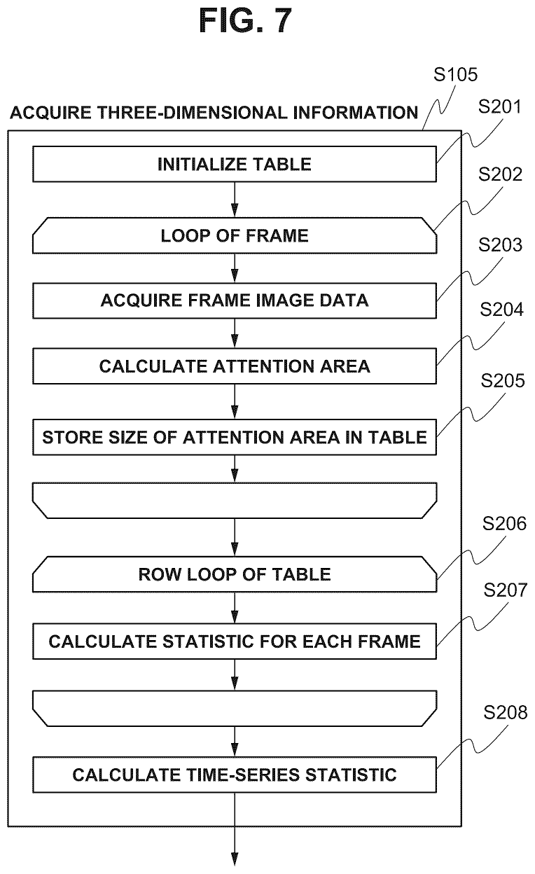

The processing of calculating the statistics amount of the size of the attention area will be described with reference to FIG. 7, which is a flowchart illustrating the processing of step S105 in detail.

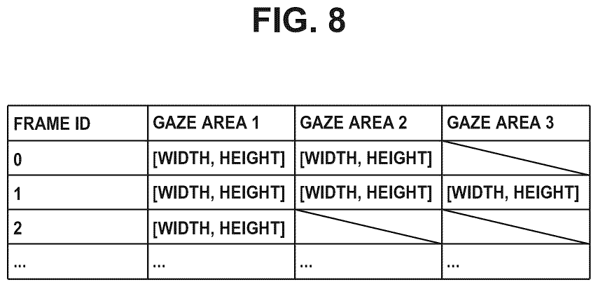

In step S201, the attention area calculation unit 31 initializes a table that stores an attention area group made up of a plurality of spatially or temporally different attention areas of thumbnail data. FIG. 8 illustrates an example of the table. A frame ID is stored in a first column. The sizes of attention areas to be specified by processing to be described below in thumbnail data corresponding to the frame ID in the first column are stored in second and subsequent columns. The size includes the number of pixels of Width and Height of the attention area. The table does not have to be as illustrated in FIG. 8. The table is saved the RAM 102, for example, and is used in subsequent processing.

In step S202, the attention area calculation unit 31 starts frame looping of thumbnail data. If there is a frame for which an attention area has not yet been specified, the proceeding proceeds to step S203, and if processing of specifying an attention area has been applied to all frames, the processing proceeds to step S206.

In step S203, the attention area calculation unit 31 acquires frame image data of the thumbnail data.

In step S204, the attention area calculation unit 31 calculates the size of the attention area. As the attention area, an object and its size are detected using, for example, a known object detection technique, and the size of the object is set as the size of the attention area. A plurality of objects may be detected for each frame. It is not necessary to set all detected objects as attention areas, and the attention area may be calculated by excluding objects with small sizes from detection results by threshold processing.

In step S205, the attention area calculation unit 31 stores the size of the attention area, which calculated in step S204, in the table. When a plurality of objects is detected, the sizes of the plurality of attention areas are stored in a column direction of the corresponding Frame ID, as in the table illustrated in FIG. 8.

In step S206, the three-dimensional information calculation unit 21 starts looping in a row direction of the table.

If there is a row to which looping processing is not applied, the processing proceeds to step S207. Once the looping has completed for all rows of the table, the proceeding proceeds to step S208.

In step S207, the three-dimensional information calculation unit 21 calculates a statistics amount of the size of the attention area for each frame. For example, a size average of the attention area for each frame is acquired as the statistics amount. The statistics amount of the size of the attention area for each frame is saved as a list in a storage area such as the RAM 102. The statistics amount is not limited to the average value. For example, the statistics amount may be a median value. The average value and the median value can reduce an effect that a small attention area is momentarily reflected in a wide viewing angle video, and as a result of this, the thumbnail data display area becomes larger than necessary.

In step S208, the three-dimensional information calculation unit 21 calculates a time series statistics amount of the size of the attention area. As for the time series statistics amount, for example, a frame average value is calculated from the list of the statistics amount for each frame saved in step S208. Next, the proceeding proceeds to step S106.

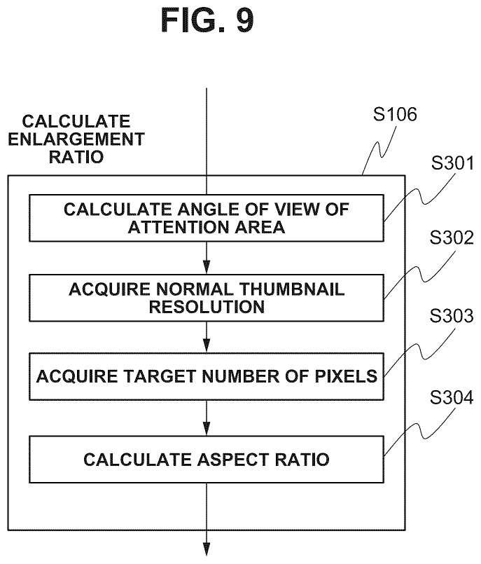

With regard to the calculation of an enlargement ratio, in step S106, the enlargement ratio calculation unit 13 calculates an enlargement ratio from the time series statistics amount calculated in step S208. The processing will be described with reference to FIG. 9, which is a flowchart illustrating the processing of step S106 in detail.

In step S301, the enlargement ratio calculation unit 13 calculates an angle of view corresponding to the time series statistics amount of the size of the attention area. The angle of view of the attention area is acquired from the ratio of the attention area in the wide viewing angle video. For example, it is assumed that the resolution of the attention area is (RES_X2, RES_Y2) with respect to the resolution of the wide viewing angle video (RES_X1, RESY1). The (horizontal angle of view, vertical angle of view) of the wide viewing angle video are (FOV_H_TARGET, FOV_V_TARGET). At this time, the angle of view (FOV_H_FOCUS, FOV_V_FOCUS) of the attention area is determined by Formulas (3) and (4).

$$FOV\_H \_FOCUS = FOV\_H \_TARGET \times RES\_X2 / RES\_X1 \qquad ( 3 )$$

$$FOV\_V \_FOCUS = FOV\_V \_TARGET \times RES\_Y2 / RES\_Y1 \qquad ( 4 )$$

In step S302, a resolution of the display area of the thumbnail data of the normal video is acquired. Let the resolution be (NORMAL_RES_X, NORMAL_RES_Y).

In step S303, a target resolution TARGET_RES is acquired. The target resolution is a sufficient resolution of the area in order to make it easy to visually recognize the attention area. The target resolution is saved on the HDD 105 in advance and then read. The target resolution may be set by a viewer via the input apparatus 107, for example.

In step S304, as the enlargement ratio, a longitudinal enlargement ratio and a lateral enlargement ratio (RATIO_X, RATIO_Y) at which a gaze area has a target resolution are calculated using Formulas (5) and (6).

$$RATIO\_X = TARGET\_RES \times \qquad ( 5 )$$

$$FOV\_H \_TARGET / FOV\_H \_FOCUS / NORMAL\_RES \_X$$

$$RATIO\_Y = TARGET\_RES \times \qquad ( 6 )$$

$$FOV\_V \_TARGET / FOV\_V \_FOCUS / NORMAL\_RES \_Y$$

Subsequently, the proceeding proceeds to step S107.

In step S204, a method of calculating an attention area is not to limited to the method using an object recognition technology.

For example, by detecting a person, the person may be an attention area. The attention area may be detected by a known unit that detects an area to which a human being is likely to pay attention. For example, an area that is likely to attract attention is detected by measuring the area to which a human being has paid attention by using a device that measures a human viewpoint, called an eye tracker. An attention area estimation unit using known deep learning may be used. A thumbnail data image may be divided into areas by using a known semantic segmentation technique, and among the divided areas, an area with a large amount of line-of-sight information, which has measured by an eye tracker, may be set as an attention area.

In step S208, a minimum value or a maximum value may be used as a statistics amount for each frame to be calculated. When the statistics amount is the minimum value, it can be expected that all the gaze areas are visually recognized with a thumbnail.

In step S204, not only the size of attention areas but also an attention degree may be acquired. As for the attention degree, for example, the attention degree and the attention area may be calculated, for example, by deep learning that outputs a value of 0 to 1, which is a known degree of attention. An attention time of viewer's line-of-sight information measured by the eye tracker may be stored for each area, and the value may be used as the attention degree. By normalizing a gaze time to 0 to 1, it is possible to reduce an influence of difference in the number of samplings of the eye tracker. Accordingly, the measurement time may be normalized to 0 to 1 and used as the attention degree.

The statistics amount for each frame calculated in step S208 may be calculated based on this attention degree. For example, the size of a representative attention area that attracts the most attention for each frame may be used as the statistics amount for each frame. The size of the attention area for each frame may be weighted by the attention degree, and the weighted average may be used as the statistics amount. The weighted average based on the attention degree is weighted by multiplying the size of the attention area by the attention degree normalized to 0 to 1, for example.

In step S209, the time series statistics amount to be calculated are not limited to the average value. For example, the median value, minimum value, or maximum value may be used. The time series statistics amount may be calculated by using the attention degree.

When the size of one attention area is used as a statistics amount for each frame, such as the minimum value, maximum value, or a size of the representative attention area, the attention degree is used. For example, the time series statistics amount is acquired by multiplying the statistics amount for each frame by the attention degree normalized to 0 to 1.

According to the present exemplary embodiment, whether it is a normal video or a high viewing angle video, a thumbnail image with good visibility can be displayed, based on the size of the attention area.

The present exemplary embodiment can be also achieved by processing of supplying a program that achieves one or more functions of the exemplary embodiments described above to a system or an apparatus via a network or a storage medium, and causing one or more processors in a computer of the system or apparatus to read and execute the program. It can also be achieved by a circuit (e.g., ASIC) that achieves one or more functions.

The visibility of thumbnail images can be improved even in a wide viewing angle video.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-102040, filed Jun. 21, 2023, which is hereby incorporated by reference herein in its entirety.

What is claimed is:

1. An image processing apparatus comprising:
one or more processors and at least one memory, the at least one memory being coupled to the one or more processors and having stored thereon instructions executable by the one or more processors, wherein the execution of the instructions cause the image processing apparatus to function as:
an acquisition unit configured to acquire a first video; and
a display control unit configured to control display so that a first display area where thumbnails of the first video are displayed is larger than a second display area where thumbnails of a second video are displayed in a case where an angle of view of the first video is larger than an angle of view of the second video.

2. The image processing apparatus according to claim 1, further comprising a calculation unit configured to calculate three-dimensional information about a video image represented by the first video,
wherein the calculation unit calculates an enlargement ratio of the first display area, based on the three-dimensional information.

3. The image processing apparatus according to claim 2, further comprising a type acquisition unit configured to acquire type information indicating whether an angle of view of the first video is larger than an angle of view of the second video,
wherein the calculation unit calculates the enlargement ratio, based on the type information.

4. The image processing apparatus according to claim 2, wherein the three-dimensional information is viewing angle information about the first video.

5. The image processing apparatus according to claim 2, wherein the three-dimensional information is depth information about the first video.

6. The image processing apparatus according to claim 2, further comprising a specifying unit configured to specify an attention area in the first video,
wherein the three-dimensional information is a size of the attention area.

7. The image processing apparatus according to claim 6,
wherein the specifying unit specifies an attention area group including a plurality of attention areas that are spatially or temporally different from each other, and
wherein a size of the attention area is a statistics amount based on sizes of the plurality of attention areas included in the attention area group.

8. A non-transitory computer-readable storage medium storing a program for causing a computer to execute an image processing method comprising:
acquiring a first video; and
controlling display so that a first display area where thumbnails of the first video are displayed is larger than a second display area where thumbnails of a second video are displayed in a case where an angle of view of the first video is larger than an angle of view of the second video.

9. An image processing method comprising:
acquiring a first video; and
controlling display so that a first display area where thumbnails of the first video are displayed is larger than a second display area where thumbnails of a second video are displayed in a case where an angle of view of the first video is larger than an angle of view of the second video.
